(19) United States
(12) Patent Application Publication
(10) Pub. No.: US 2009/0321699 A1
(43) Pub. Date: Dec. 31, 2009

(54) Spring-Loaded Cable Barrier System and Method

(75) Inventor: John F. Payne, Ennis, TX (US)

Correspondence Address: BAKER BOTTS L.L.P., 2001 ROSS AVENUE, SUITE 600, DALLAS, TX, 75201-2980, US

(73) Assignee: Payne Fence Products, LLC, Ennis, TX (US)

(21) Appl. No.: 12/495,531

(22) Filed: Jun. 30, 2009

Related U.S. Application Data
(60) Provisional application No. 61/076,906, filed on Jun. 30, 2008.

(51) Int. Cl. E04H 17/06; B23P 11/00

(52) U.S. Cl. 256/47; 29/428

(57) ABSTRACT

In certain embodiments, a barrier system includes a first terminal post, a second terminal post, and a cable spanning at least a portion of the distance between the first terminal post and the second terminal post. The system further includes a first spring member having a first end coupled to the first terminal post and a second end coupled to the cable. The system further includes a second spring member having a first end coupled to the cable and a second end coupled to the second terminal post. The system further includes a line post positioned substantially between the first terminal post and the second terminal post and a line post guide member coupled to the line post, the line post guide member maintaining a portion of the cable in proximity to the line post and adapted to allow the cable to translate laterally with respect to the line post.

### RELATED APPLICATIONS

This application claims the benefit under 35 U.S.C. §119(e) of the priority of U.S. Provisional Application No. 61/076,906, filed Jun. 30, 2008, entitled “Spring-Loaded Cable Barrier System, and Method Therefor.”

### TECHNICAL FIELD

This invention relates generally to barrier systems and more particularly to a spring-loaded cable barrier system and method.

### BACKGROUND

It is often desirable or even necessary to prevent people from crossing boundaries, such as a perimeter of privately-owned real estate or another key asset. Free-standing barriers may be used to attempt to prevent people from crossing these boundaries on foot, using a vehicle, or in other suitable ways. Conventional barriers, such as those used to attempt to prevent people from crossing boundaries, may include, for example, cable barriers, jersey barriers, and other barricade or wall systems.

### SUMMARY

According to embodiments of the present invention, disadvantages and problems associated with previous fence systems may be reduced or eliminated.

In certain embodiments, a barrier system includes a first terminal post, a second terminal post, and a cable spanning at least a portion of the distance between the first terminal post and the second terminal post. The system further includes a first spring member having a first end coupled to the first terminal post and a second end coupled to the cable. The system further includes a second spring member having a first end coupled to the cable and a second end coupled to the second terminal post. The system further includes a line post positioned substantially between the first terminal post and the second terminal post and a line post guide member coupled to the line post. The line post guide member maintains a portion of the cable in proximity to the line post and is adapted to allow the cable to translate laterally with respect to the line post.

Particular embodiments of the present invention may provide one or more technical advantages. Conventional barriers for preventing movement across a particular boundary may include, for example, cable barriers, jersey barriers, and other barricade or wall systems. Certain individuals attempting to cross the particular boundary may attempt to breach these conventional barriers, by driving a vehicle through them for example. Because of the significant force involved in an attempted breach (e.g., an attempt to drive a vehicle through a barrier system), a conventional barrier may fail (i.e., they may be ineffective in preventing these attempted breaches). Certain other conventional barriers, such as those made of concrete, bricks, metal, and/or stone, may be less likely to fail (i.e., less susceptible to being breached), but these alternative conventional barriers may be prohibitively expensive to construct along boundaries of significant length.

The barrier system of the present invention may include one or more cables, each cable coupled at each end to a spring member that is coupled to a terminal post (rather than each cable being rigidly coupled at each end to a terminal post). If an individual attempts to breach the barrier system of the present invention, such as by driving a vehicle through the barrier system, the applied force (e.g., resulting from a car being driving into barrier system) may be transferred from the cables to the spring members to which the cables are coupled such that the spring members may absorb some or all of the applied force. As a result, less stress may be placed on the cables, thereby decreasing the likelihood that the cables with fail. In other words, the force required to breach the barrier system of the present invention may be greater than conventional barrier systems, making the barrier system less likely to fail as a result of an attempted breach (i.e., less susceptible to being breached).

Additionally, the barrier system of the present invention may not be prohibitively expensive to construct along boundaries of significant length, potentially making it a more cost effective solution for certain applications. Furthermore, the barrier system of the present invention may be less susceptible to damage than certain other barrier systems (e.g., those made of concrete, bricks, metal, and/or stone), such as damage resulting from high winds and/or soil movement.

Certain embodiments of the present invention may include some, all, or none of the above advantages. One or more other technical advantages may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description taken in conjunction with the accompanying drawings, in which:

FIGS. 1A-1D illustrate an example barrier system, according to certain embodiments of the present invention;

FIG. 2 illustrates an alternative configuration of the example barrier system illustrated in FIG. 1, according to certain embodiments of the present invention; and

FIG. 3 illustrates an example method for constructing a barrier system, according to certain embodiments of the present invention.

### DESCRIPTION OF EXAMPLE EMBODIMENTS

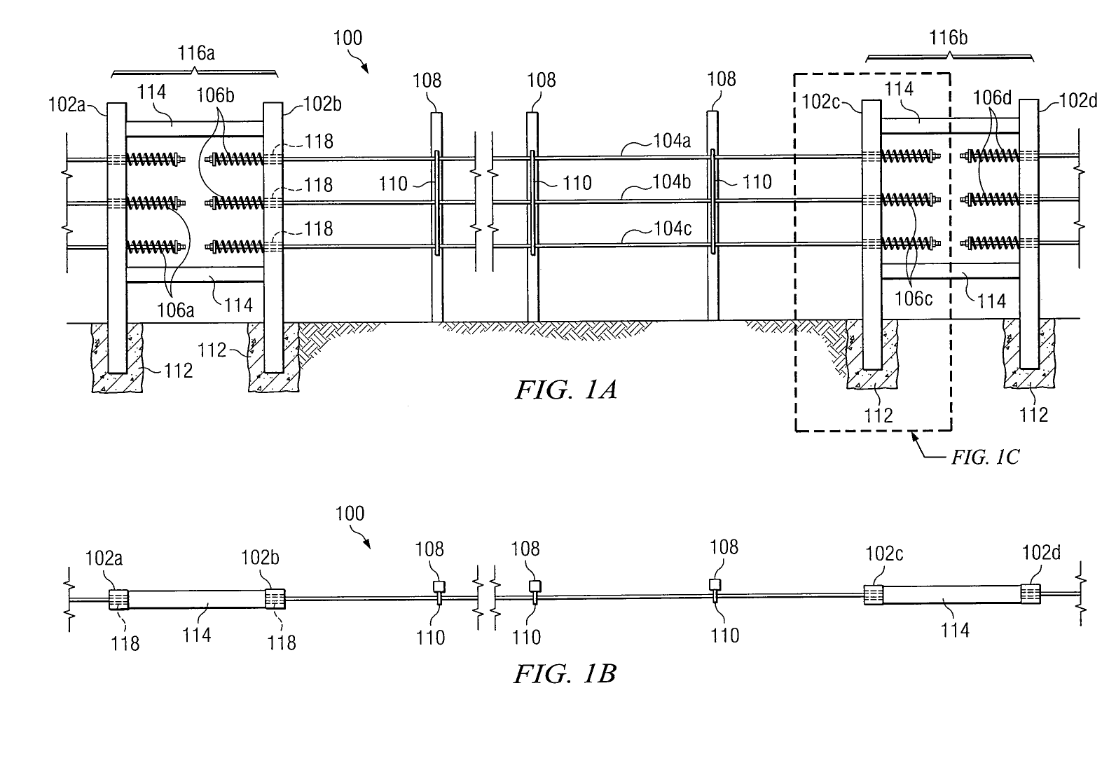

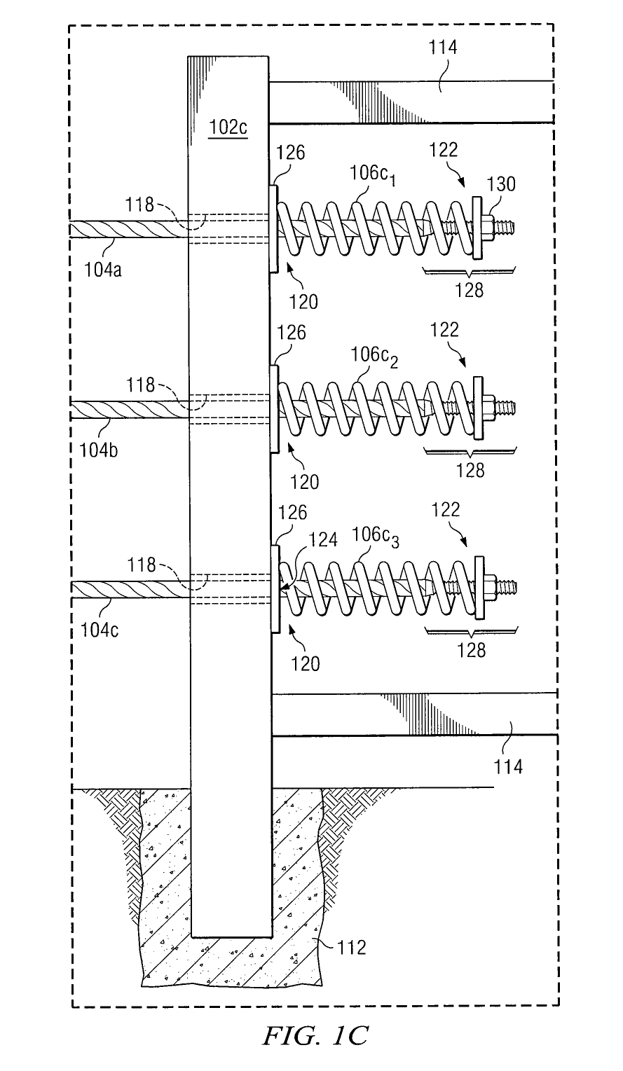

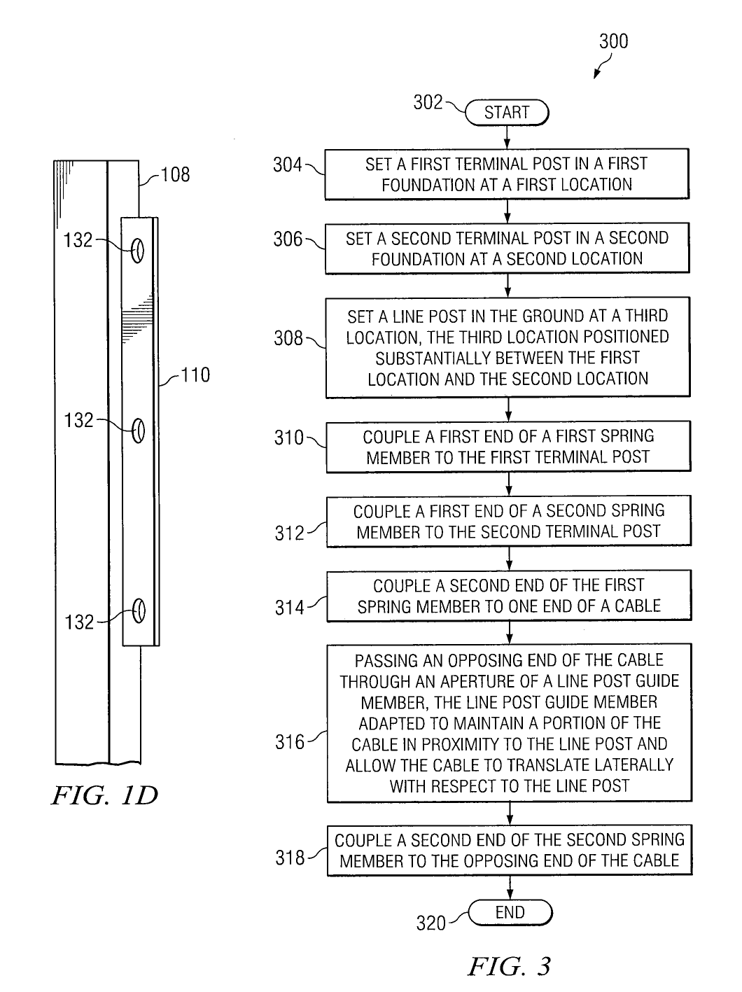

FIGS. 1A-1D illustrate an example barrier system 100, according to certain embodiments of the present invention. Barrier system 100 may include a number of terminal posts 102 and one or more cables 104. The one or more cables 104 may be coupled to a particular terminal post 102 at each end using a spring member 106. Additionally, each of the one or more cables 104 may be coupled to each of one or more line posts 108 with a line post guide member 110 adapted to allow each cable 104 to translate laterally with respect to each line post 108.

In general, barrier system 100 is adapted to deter and/or substantially prevent vehicular movement across a particular boundary. Example boundaries include perimeters of critical assets, perimeters of privately-owned real estate, or any other suitable boundary. Certain individuals attempting to cross the particular boundary may attempt to breach barrier system 100, such as by driving a vehicle through barrier system 100. If such a breach is attempted, a significant amount of force may be applied to one or more cables 104 of barrier system 100. Because cables 104 are attached to terminal posts 102 with spring members 106, the applied force (e.g., resulting from a vehicle being driving into barrier system 100) may be at least partially transferred from cables 104 affected by the applied force to spring members 106, allowing the cables 104 affected by the applied force to deflect, and the spring members 106 to temporarily absorb, at least a portion of the applied force; lengthening the deceleration time. As a result, less stress may be placed on cables 104, thereby decreasing the likelihood that cables 104 will fail. Thus, the force required to breach barrier system 100 may be greater than conventional barrier systems, making barrier system 100 less susceptible to being breach relative to conventional barrier systems.

Terminal posts 102 of barrier system 100 may be constructed from aluminum, iron, stainless steel, galvanized steel, brass, or any other suitable material. Furthermore, terminal posts 102 may have any suitable shape and size. For example, terminal posts 102 may be constructed from tubing material of any desired cross section (e.g., rectangular, round, elliptical), solid material of any desired cross section (e.g., rectangular, round, elliptical), angle iron, I-beam, or any other suitable material. Furthermore, terminal posts 102 may be any suitable length (e.g., four, eight, or twenty feet). As a particular example, terminal posts 102 may be constructed from an eight foot length of galvanized steel round tubing.

Terminal posts 102 may be anchored in the ground, such as by using concrete 112. In certain embodiments, terminal posts 102 are anchored in the ground such that they are substantially vertical (and, as a result, substantially parallel with one another) regardless of ground slope. Furthermore, the distance between any two adjacent terminal posts 102 (e.g., terminal post 102a and terminal post 102b) may be any suitable distance (e.g., 250 feet), and may vary, according to particular needs.

In certain embodiments, certain adjacent terminal posts 102 (e.g., terminal posts 102a and 102b in the illustrated example) may be coupled together by one or more rails 114. These adjacent terminal posts 102 coupled by one or more rails 114 may be referred to as a combined terminal post section 116. Adjacent terminal posts 102 may be coupled together using any suitable number of rails 114, according to particular needs. Additionally, rails 114 may be constructed from aluminum, iron, stainless steel, galvanized steel, brass, or any other suitable material. Rails 114 may be coupled to terminal posts 102 in any suitable manner. Combined terminal post section 116 may be prefabricated, prior to installing barrier system 100, or may be assembled as part of installing barrier system 100 at its intended site.

In certain embodiments, each terminal post 102 includes one or more apertures 118. Apertures 118 may be round, rectangular, or any other suitable shape. In certain embodiments, the shape of apertures 118 corresponds to the cross-sectional shape of cables 104. Additionally, the size of apertures 118 may be sufficiently large to allow at least a portion of cable 104 to pass through each aperture 118, as described in further detail below.

Cables 104 may be constructed of any suitable material and have any suitable size and shape. For example, cables 104 may be constructed from stainless steel, galvanized steel, aluminum, nylon, brass, or any other suitable material. Furthermore, cables 104 may have any desired cross-sectional shape (e.g., rectangular, round, elliptical) and any suitable diameter/thickness (e.g., ¾ or 1 inch). As a particular example, cables 104 may be constructed of a length of 1 inch diameter galvanized steel wire rope. Although a particular number of cables 104 are illustrated and described, the present invention contemplates barrier system 100 including any suitable number of cables 104, according to particular needs.

Additionally, cables 104 may be any suitable length. In certain embodiments, the length of cables 104 may be dependent upon the distance between two adjacent terminal posts 102 (e.g., terminal post 102b and terminal post 102c, assuming there is no other terminal post 102 between them in this example). For example, if two adjacent terminal posts (e.g., terminal post 102b and terminal post 102c, assuming there is no other terminal post 102 between them in the illustrated example) are spaced 250 feet apart, a cable 104 spanning the distance between the two adjacent terminal posts may be slightly longer than 250 feet such that the cable 104 may pass through apertures 118 in each terminal post 102 and be attached to a spring member 106, as described below.

In certain embodiments, each end portion of each cable 104 is attached to a second end 122 of a spring member 106, the first end 120 of the spring member 106 being attached to a terminal post 102. In other words, each end of a cable 104 may be attached to a terminal posts 102 via a spring member 106. Reference to the “end” of a component throughout this description may include the endpoint of the component or an end portion of the component, as appropriate. Spring members 106 may be compression springs constructed of any suitable material. For example, spring members 106 may be compression coil springs constructed of steel or rubber, such as the rubber springs made by TIMBREN INDUSTRIES, INC. Additionally, spring member 106 (e.g., compression coil springs) may have any suitable diameter and any suitable stiffness, according to particular needs.

The first end 120 of a spring member 106 may be coupled to a terminal post 102 such that the opening 124 defined by the spring member 106 (e.g., the opening defined by the coils of the spring member 106) overlays at least a portion of an aperture 118 of the terminal post 102. As a result, a cable 104 may pass through both the aperture 118 of the terminal post 102 and the opening 124 defined by the spring member 106 (and into the hollow defined by the coils of spring member 106) such that cable 104 may be attached to the second end 122 of the spring member 106, as described below.

In certain embodiments, first end 120 of spring member 106 may be coupled to terminal post 102 such that first end 120 of spring member 106 is physically attached to the terminal post 102 (or a washer 126 or other component that is physically attached to the terminal post 102). For example, first end 120 of spring member 106 may be welded, bolted, screwed, riveted, or otherwise physically attached to terminal post 102. In certain other embodiments, first end 120 of spring member 106 may be coupled to terminal post 102 such that the first end 120 of the spring member 106 is not physically attached to the terminal post 102. For example, cable 104 may be under tension, and the tension may be transferred by spring member 106 (as cable 104 is coupled to second end 122 of spring member 106) resulting in a force causing first end 120 of spring member 106 to remain in physical contact with the terminal post 102 (or a washer 126, which remains in contact with the terminal post 102). In any of the above-described scenarios, first end 120 of spring member 106 may be described as being “coupled to” terminal post 102.

The second end 122 of a spring member 106 may be coupled to cable 104, the cable 104 passing though both the aperture 118 in the terminal post 102 to which the spring member 106 is attached and the opening defined by the spring member 106 (and into the hollow defined by the coils of spring member 106), as described above.

In certain embodiments, the second end 122 of a spring member 106 may be coupled to a cable 104 such that the second end 122 of the spring member 106 is physically attached to the cable 104. For example, cable 104 may have a threaded stud 128. A nut 130 may be attached to the threaded stud 126 of the cable 104, and the nut 130 may be physically attached to the second end 122 of a spring member 106 (or a washer 126 that is physically attached to the second end of the spring member 106). For example, a nut 130 may be attached to the threaded stud 128 of a cable 104, and the nut 130 may be welded, bolted, screwed, riveted, or otherwise physically attached to a spring member 106. In certain other embodiments, the second end 122 of a spring member 106 may be coupled to a cable 104 such that the second end 122 of the spring member 106 is not physically attached to the cable 104. For example, cable 104 may be under tension, and the tension may cause a nut 130 attached to the threaded stud 128 of a cable 104 to remain in physical contact with the second end 122 of a spring member 106 (or a washer 126, which remains in contact with the second end 122 of a spring member 106). In any of the above-described scenarios, second end 122 of spring member 106 may be described as being “coupled to” cable 104.

In certain embodiments, spring members 106 extend into a region between the terminal posts 102 (e.g., terminal posts 102a and 102b) of a combined terminal post section 116. Rails 114 of combined terminal post section 116 may provide additional resistance to breach in this region where no cable 104 may span the distance between terminal posts 102 (e.g., terminal posts 102a and 102b). In certain embodiments, a cover may overlay the region between the terminal posts 102 (e.g., terminal posts 102a and 102b) of a combined terminal post region 116. Such a cover may include any suitable material (e.g., steel, stone, plastic, or any other suitable material) and may protect spring members 106 from tampering or damage. The cover may overlay rails 114 or may replace rails 144 in a suitable configuration.

Line posts 108 may be constructed from aluminum, iron, stainless steel, galvanized steel, brass, or any other suitable material. Furthermore, line posts 108 may have any suitable shape and size. For example, line posts 108 may be constructed from tubing material of any desired cross section (e.g., rectangular, round, elliptical), solid material of any desired cross section (e.g., rectangular, round, elliptical), angle iron, I-beam, or any other suitable material. Furthermore, line posts 108 may be any suitable length (e.g., four, eight, or twenty feet), and the length of line posts 108 may correspond to the length of terminal posts 102, described above, if appropriate. As a particular example, line posts 108 may be constructed from an eight foot length of galvanized steel round tubing.

Line posts 108 may be anchored in the ground (e.g., using concrete or by being driving into the soil) along or near an area between two adjacent terminal posts 102 (e.g., terminal post 102b and terminal post 102c). For example, line posts 108 may be anchored in the ground using concrete or another suitable substance, or by simply driving them into the soil. In certain embodiments, line posts 108 may be anchored in the ground such that they are substantially vertical (and, as a result, substantially parallel with one another as well as terminal posts 102) regardless of ground slope. Furthermore, the distance between any two adjacent line posts 108 may be any suitable distance (e.g., fifty feet). For example, five line posts 108 may be anchored in the ground along a path (e.g., a line or series of lines) between two adjacent terminal posts 102 (e.g., terminal post 102b and terminal post 102c) spaced 250 feet apart such that the line posts 108 are evenly spaced (e.g., fifty feet apart). The combination of a first terminal post 102b, a second terminal post 102c, and one or more line posts 108 between first and second terminal posts 102b and 102c that are intended to form a portion of barrier system 100 may or may not be positioned in a substantial straight line.

One or more line posts 108 of barrier system 100 may include one or more line post guide members 110. The one or more line post guide members 110 of a line post 108 coupled (e.g., welded, bolted, screwed, riveted, or otherwise attached) to line post 108 in any suitable manner. Additionally or alternatively, the one or more line post guide members 110 of a line post 108 may be formed on line post 108 as part of the formation of line post 108 (e.g., as part of a casting or molding process).

A line post guide member 110 may include any member adapted to maintain at least a portion of one or more cables 104 of barrier system 100 in proximity to line post 108 and adapted to allow the one or more cables 104 to translate laterally with respect to the line post 108. In certain embodiments, at least a portion of each cable 104 may be maintained in proximity to one or more line posts 108 using one or more line post guide members 110. Line post guide members 110 may hold a portion of a cable 104 passing through an aperture of the line post guide member 110 in proximity to the line post 108 by preventing the cable 104 from moving too far from the line post 108 in certain directions. For example, while allowing the cable 104 to translate laterally with respect to the line post 108, line post guide member 110 may prevent cable 104 from moving too far in an upward direction, a downward direction, a direction toward the line post 108, or a direction away from the line post 108 in response to an applied force (e.g., gravity, wind, a human attempting to displace the cable 104, a vehicle attempting to drive through the cable 104, or another suitable force).

In certain embodiments, line post guide members 108 may include generally rectangular plates (constructed of any suitable material, such as stainless steel, galvanized steel, iron, brass, or aluminum) having apertures 132, wire hooks, wire rings (e.g. D rings), or any other suitable member adapted to maintain at least a portion of one or more of the cables 104 of barrier system 100 in proximity to the line post 108 and adapted to allow the one or more cables 104 to translate laterally with respect to the line post 108. The present invention contemplates line post 108 including multiple line post guide members 110 each having one or more apertures 132. Apertures 132 of line post guide members 110 may have any suitable shape and size, and may be able to accommodate one or more cables 104. As a particular example, the present invention contemplates line post guide member 110 having a single aperture 132 running substantially the length of line post guide member 110 and that is able to accommodate multiple cables 104.

As a particular example (as illustrated in FIG. 1D), line post guide members 110 may be rectangular steel plates welded to corresponding line posts 108 and having apertures 132 corresponding to each cable 104 of barrier system 100. Furthermore, each cable 104 of barrier system 100 may pass through a corresponding aperture 132 in a line post guide member 110 such that at least a portion of the cable 104 is maintained in proximity to the line post 108 and may translate laterally with respect to the line post 108 to which the line post guide member 110 is coupled (e.g., welded).

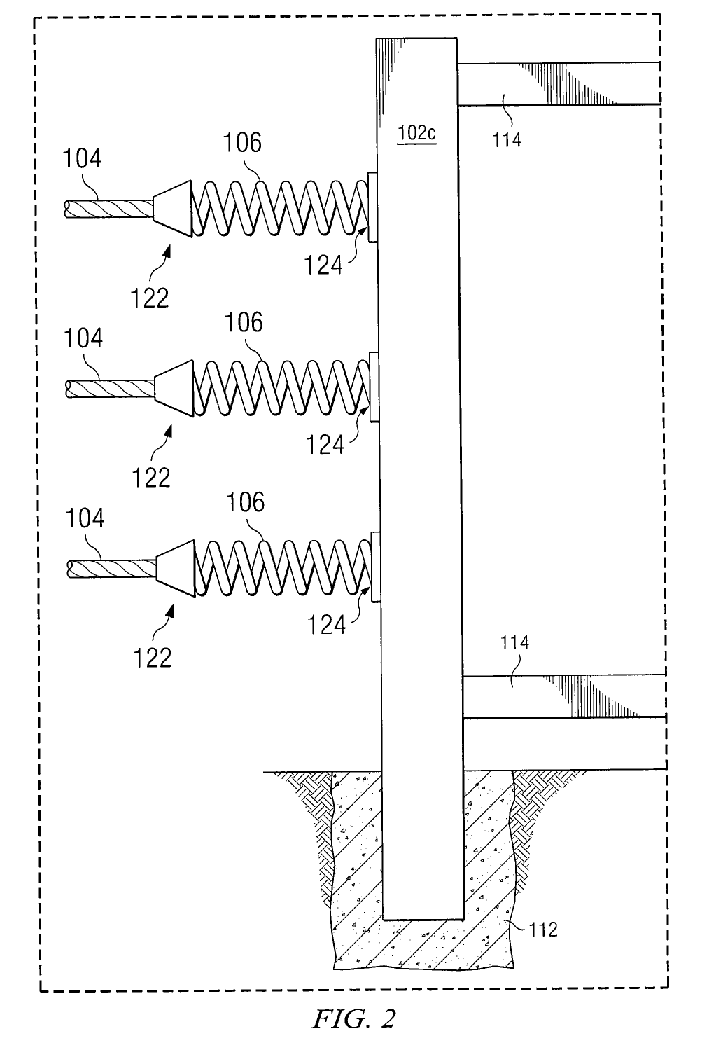

In certain embodiments, some or all of the above-described structure associated with barrier system 100 may cause the force applied to one or more cables 104 of barrier system 100 resulting from an attempted breach of barrier system (e.g., an individual attempting to drive a vehicle through barrier system 100) to be transferred to the spring members 106 attached to either end of the cable 104. Because the cable 104 is coupled to line posts 108 with line post guide members 110 that maintain at least a portion of cable 104 in proximity to line post 108 and allow cable 104 to translate with respect to line posts 108, cable 104 may deflect in the direction of the applied force, resulting in the compression (or extension, as described below in FIG. 2) of the spring members 106 to which the cable 104 is attached. The compression (or extension, as described below in FIG. 2) of spring members 106 may dissipate some or all of the applied force, thereby reducing the stress on the cable 104 and reducing the likelihood that the cable 104 will fail. Thus, the force required to breach barrier system 100 may be greater than conventional barrier systems, making barrier system 100 less susceptible to breach relative to conventional (cable) barrier systems.

Although a particular implementation of barrier system 100 is illustrated and primarily described, the present invention contemplates any suitable implementation of barrier system 100 according to particular needs. Although a particular number of components of barrier system 100 have been illustrated and primarily described above, the present invention contemplates barrier system 100 including any suitable number of components, according to particular needs.

As just one alternative example, cables 104 may be rigidly coupled directly to a terminal post 102 at one end of the cables 104, while a second end of cables 104 are coupled to a second terminal post 102 using a spring member 106. In this configuration, only one end of each cable 104 is connected to a terminal post 102 using a spring member 106. As another example, in embodiments in which barrier system 100 includes multiple cables 104, it is possible that only a portion of cables 104 are coupled to terminal posts 102 using spring members 106.

FIG. 2 illustrates an alternative configuration of the example barrier system 100 illustrated in FIG. 1, according to certain embodiments of the present invention. As described above, barrier system 100 may include a number of terminal posts 102 and one or more cables 104. The cables 104 may be coupled to a particular terminal post 102 at each end with a spring member 106. More particularly, each end of each cable 104 may be attached to a second end 122 of a spring member 106, the first end 120 of the spring member 106 being attached to a terminal post 102.

In the illustrated embodiment, spring members 106 may be extension springs (rather than compression springs, as described above with regard to FIG. 1). For example, spring members 106 may be extension coil springs constructed of any suitable material (e.g., steel or rubber, such as the rubber springs made by TIMBREN INDUSTRIES, INC.) and having any suitable diameter and any suitable stiffness, according to particular needs.

The first end 120 of a spring member 106 may be coupled to a terminal post 102. In certain embodiments, the first end 120 of a spring member 106 may be coupled to a terminal post 102 such that the first end 120 of the spring member 106 is physically attached to the terminal post 102. For example, the first end 120 of a spring member 106 may be welded, bolted, screwed, riveted, or otherwise physically attached to terminal post 102. In certain other embodiments, the first end 120 of a spring member 106 may be coupled to a terminal post 102 such that the first end 120 of the spring member 106 is not physically attached to the terminal post 102. For example, the first end 120 of spring member 106 may include a hook that is engaged with a corresponding hook (or ring) attached to terminal post 102. Additionally, cable 104 may be under tension, and the tension may be transferred by the spring member 106 (as the cable is coupled to the second end 122 of the spring member 106) resulting in a force causing the hook of the first end 120 of the spring member 106 to remain in engagement with (i.e., coupled to) the corresponding hook (or ring) of terminal post 102.

The second end 122 of a spring member 106 may be coupled to cable 104. In certain embodiments, the second end 122 of a spring member 106 may be coupled to a cable 104 such that the second end 122 of the spring member 106 is physically attached to the cable 104. For example, the second end 122 of a spring member 106 may be welded, bolted, screwed, riveted, or otherwise physically attached to cable 104. In certain other embodiments, the second end 122 of a spring member 106 may be coupled to a cable 104 such that the second end 122 of the spring member 106 is not physically attached to the cable 104. For example, the second end 122 of spring member 106 may comprise a hook that is engaged with a corresponding hook (or ring) attached to cable 104. Additionally, cable 104 may be under tension, the tension resulting in a force causing the hook of the second end 122 of the spring member 106 to remain in engaged with (i.e., coupled to) the corresponding hook (or ring) of cable 104.

In certain embodiments, some or all of the above-described structure associated with barrier system 100 may cause the force applied to one or more cables 104 of barrier system 100 resulting from an attempted breach of barrier system (e.g., an individual attempting to drive a vehicle through barrier system 100) to be transferred to the spring members 106 attached to either end of the cable 104. Because the cable 104 is coupled to line posts 108 with line post guide members 110 that maintain at least a portion of cable 104 in proximity to line post 108 and allow cable 104 to translate with respect to line posts 108, cable 104 may deflect in the direction of the applied force, resulting in the extension of the spring members 106 to which the cable 104 is attached. The extension of spring members 106 may dissipate some or all of the applied force, thereby reducing the stress on the cable 104 and reducing the likelihood that the cable 104 will fail. Thus, the force required to breach barrier system 100 may be greater than conventional barrier systems, making barrier system 100 less susceptible to breach relative to conventional barrier systems.

FIG. 3 illustrates an example method 300 for constructing a barrier system, according to certain embodiments of the present invention. The method begins at step 302. At step 304, a first terminal post 102 (e.g., terminal post 102b) b may be set in a first foundation (e.g., concrete 112) at a first location. At step 306, a second terminal post 102 (e.g., terminal post 102c) may be set in a second foundation (e.g., concrete 112) at a second location. In certain embodiments, terminal posts 102 are part of a combined terminal post section 116 such that setting a terminal post 102 may include setting two terminal posts 102 (e.g., setting terminal posts 102a and 102b). At step 308, line post 108 may be set in the ground (e.g., driven into the soil and secured by concrete or another suitable material) at a third location. The third location may be positioned substantially between the first location and the second location.

At step 310, a first end 120 of a first spring member 106 (e.g., spring member 106b₁) may be coupled to the first terminal post 102 (e.g., terminal post 102b). At step 312, a first end 120 of a second spring member 106 (e.g., spring member 106c₁) may be coupled to the second terminal post (e.g., terminal post 102c). As described above, first end 120 of spring member 106b₁ may be coupled to a terminal post 102b such that the opening 124 defined by spring member 106b₁ (e.g., the opening defined by the coils of the spring member 106b₁) overlays at least a portion of an aperture 118 of terminal post 102b. Similarly, first end 120 of spring member 106c₁ may be coupled to a terminal post 102c such that the opening 124 defined by spring member 106c₁ (e.g., the opening defined by the coils of the spring member 106c₁) overlays at least a portion of an aperture 118 of terminal post 102c. As a result, one end of a cable 104 (e.g., cable 104a) may pass through both the aperture 118 of terminal post 102b and the opening 124 defined by the spring member 106b₁ and the other end of the cable 104 (e.g., cable 104a) may pass through both the aperture 118 of terminal post 102c and the opening 124 defined by the spring member 106c₁ such that each end of the cable 104 may be attached to either the second end 122 of the spring member 106b₁ or the second end 122 of the spring member 106c₁, as described below.

In certain embodiments, the first ends 120 of spring members 106b₁ and 106c₁ may be physically attached to terminal posts 102b and 102c, respectively (or washers 126 that are physically attached to the terminal posts 102b and 102c). For example, first ends 120 of a spring members 106b₁ and 106c₁ may be welded, bolted, screwed, riveted, or otherwise physically attached to terminal post 102b and 102c, respectively. In certain other embodiments, the first ends 120 of a spring members 106b₁ and 106c₁ may not be physically attached to terminal posts 102b and 102c, respectively. For example, cable 104 may be under tension, and the tension may be transferred by spring members 106b₁ and 106c₁ resulting in a force causing the first ends 120 of spring members 106b₁ and 106c₁ to remain in physical contact with (i.e., coupled to) the terminal posts 102b and 102c, respectively (or a washer 126, which remains in contact with terminal posts 102b and 102c).

At step 314, a second end 122 of the first spring member 106 (e.g., spring member 106b₁) is coupled to one end of a cable 104 (e.g., cable 104a). Example techniques for performing step 314 are described below with respect to step 318.

At step 316, an opposing end of cable 104 may be passed through an aperture 132 of line post guide member 110. Line post guide member 132 may be adapted to maintain a portion of cable 104 in proximity to line post 108 and allow cable 104 to translate laterally with respect to line post 108. Line post guide member 110 may already be attached to line post 108 or subsequently may be coupled to line post 108 as part of the assembly of barrier system 100.

At step 318, a second end of the second spring member 106 (e.g., spring member 106c₁) is coupled to an opposing end of the cable 104 (e.g., cable 104a). In certain embodiments, regarding steps 314 and 318, the second ends 122 of spring members 106b₁ and 106c₁ may be physically attached to the opposing ends of cable 104a. For example, cable 104a may comprise threaded studs 128 at each end. A nut 130 may be attached to the threaded stud 126 at each end of the cable 104a, and each nut 130 may be physically attached to either the second end 122 of spring member 106b₁ or the second end 122 of member 106c₁. For example, a nut 130 may be attached to the threaded stud 128 at each end of a cable 104a, and the nut 130 at one end of cable 104a may be welded, bolted, screwed, riveted, or otherwise physically attached to spring member 106b₁ and the nut 130 at the opposing end of cable 104a may be welded, bolted, screwed, riveted, or otherwise physically attached to spring member 106c₁.

In certain other embodiments, the second ends 122 of a spring members 106b₁ and 106c₁ may not be physically attached to the opposing ends of the cable 104a. For example, cable 104a may be under tension, and the tension may cause a nut 130 attached to the threaded stud 128 at either end of cable 104a to remain in physical contact with (i.e., coupled to) the second ends 122 of spring members 106b₁ and 106c₁ (or a washers 126, which remain in contact with the second ends 122 of spring members 106b₁ and 106c₁).

Although a particular method for constructing barrier system 100 has been described with reference to FIG. 3, the present invention contemplates any suitable methods in accordance with the present invention. Thus, certain of the steps described with reference to FIG. 3 may take place substantially simultaneously and/or in different orders than as shown and described. Moreover, the methods may include additional steps, fewer steps, and/or different steps, so long as the methods remain appropriate. For example, although setting of a single line post 108 has been described in FIG. 3, those of ordinary skill in the art will appreciate that any suitable number of line posts 108 may be set between adjacent terminal posts 102. As another example, although a particular number of cables 104 described, the present invention contemplates providing any suitable number of cables 104 according to particular needs.

Although the present invention has been described with several embodiments, diverse changes, substitutions, variations, alterations, and modifications may be suggested to one skilled in the art, and it is intended that the invention encompass all such changes, substitutions, variations, alterations, and modifications as fall within the spirit and scope of the appended claims.

What is claimed is:

1. A barrier system, comprising:
a first terminal post;
a second terminal post;
a cable spanning at least a portion of the distance between the first terminal post and the second terminal post;
a first spring member comprising a first end coupled to the first terminal post and a second end coupled to the cable;
a second spring member comprising a first end coupled to the cable and a second end coupled to the second terminal post; and
a line post positioned substantially between the first terminal post and the second terminal post; and
a line post guide member coupled to the line post, the line post guide member maintaining a portion of the cable in proximity to the line post and adapted to allow the cable to translate laterally with respect to the line post.

2. The system of claim 1, wherein:
the first terminal post comprises a first aperture; and
the first spring member comprises a compression coil spring defining a first opening, the first end of the first spring member being coupled to the first terminal post such that the first opening overlays at least a portion of the first aperture and the second end of the first spring member being coupled to the cable such that the cable passes through both the first aperture and the first opening.

3. The system of claim 2, wherein:
the second terminal post comprises a second aperture; and
the second spring member comprises a compression coil spring defining a second opening, the first end of the second spring member being coupled to the second terminal post such that the first opening overlays at least a portion of the second aperture and the second end of the second spring member being coupled to the cable such that the cable passes through both the second aperture and the second opening.

4. The system of claim 1, wherein the cable, in response to an applied force, is allowed to deflect in the direction of the applied force by compressing the first and second spring members.

5. The system of claim 1, wherein the first spring member comprises an extension spring, the first end of the first spring member being coupled to the first terminal post and the second end of the first spring member being coupled to the cable such that the first spring member is positioned between the cable and the first terminal post.

6. The system of claim 5, wherein the second spring member comprises an extension spring, the first end of the second spring member being coupled to the second terminal post and the second end of the second spring member being coupled to the cable such that the second spring member is positioned between the cable and the second terminal post.

7. The system of claim 1, wherein the cable, in response to an applied force, is allowed to deflect in the direction of the applied force by extending the first and second spring members.

8. The system of claim 1, wherein the line post guide member comprises a plate comprising an aperture, the cable passing through the aperture of the plate.

9. The system of claim 1, wherein the first terminal post is part of a combined terminal post section that comprises a third terminal post, the first terminal post and the third terminal post being coupled using one or more rails.

10. A method of constructing a barrier system, comprising:
setting a first terminal post in a first foundation at a first location;
setting a second terminal post in a second foundation at a second location;
setting a line post in the ground at a third location, the third location positioned substantially between the first location and the second location;
coupling a first end of a first spring member to the first terminal post;
coupling a first end of a second spring member to the second terminal post;
coupling a second end of the first spring member to one end of a cable;
passing an opposing end of the cable through an aperture of a line post guide member, the line post guide member adapted to maintain a portion of the cable in proximity to the line post and allow the cable to translate laterally with respect to the line post; and
coupling a second end of the second spring member to an opposing end of the cable.

11. The method of claim 10, wherein:
the first terminal post comprises a first aperture;
the second terminal post comprises a second aperture;
the first spring member comprises a compression coil spring defining a first opening; and
the second spring member comprises a compression coil spring defining a second opening.

12. The method of claim 11, comprising:
coupling the first end of the first spring member to the first terminal post such that the first opening overlays at least a portion of the first aperture;
coupling a first end of the second spring member to the second terminal post such that the second opening overlays at least a portion of the second aperture;
coupling the second end of the first spring member to one end of the cable such that the cable passes through both the first aperture and the first opening; and
coupling the second end of the second spring member to an opposing end of the cable such that the cable passes through both the second aperture and the second opening.

13. The method of claim 10, wherein the cable, in response to an applied force, is allowed to deflect in the direction of the applied force by compressing the first and second spring members.

14. The method of claim 10, wherein:
the first spring member comprises an extension spring; and
the method comprises coupling the first end of the first spring member to the first terminal post and the second end of the first spring member to one end of the cable such that the first spring member is positioned between the cable and the first terminal post.

15. The method of claim 14, wherein:
the second spring member comprises an extension spring.
the method comprises coupling the first end of the second spring member to the second terminal post and the second end of the second spring member to the opposing end of the cable such that the second spring member is positioned between the cable and the second terminal post.

16. The method of claim 10, wherein the cable, in response to an applied force, is allowed to deflect in the direction of the applied force by extending the first and second spring members.

17. The method of claim 10, wherein the line post guide member comprises a plate defining an aperture, the cable passing through the aperture defined by the plate.

18. The method of claim 10, wherein the first terminal post is part of a combined terminal post section that comprises a third terminal post, the first terminal post and the third terminal post being coupled using one or more rails.

19. A barrier system, comprising:
a first terminal post comprising a first aperture;
a second terminal post comprising a second aperture;
a cable spanning at least a portion of the distance between the first terminal post and the second terminal post;
a first compression spring member defining a first opening, the first compression spring member comprising:
a first end coupled to the first terminal post such that the first opening overlays at least a portion of the first aperture; and
a second end coupled to the cable such that the cable passes through both the first aperture and the first opening;
a second compression spring member defining a second opening, the second compression spring member comprising:
a first end coupled to the second terminal post such that the second opening overlays at least a portion of the second aperture; and
a second end coupled to the cable such that the cable passes through both the second aperture and the second opening
a line post positioned between the first terminal post and the second terminal post; and
a line post guide member coupled to the line post, the line post guide member comprising a plate comprising an aperture, the cable passing through the aperture of the plate such that the cable maintained in proximity to the line post while being able to translate laterally with respect to the line post.

20. The system of claim 19, wherein the first terminal post is part of a combined terminal post section that comprises a third terminal post, the first terminal post and the third terminal post being coupled using one or more rails.
